(19) United States
(12) Patent Application Publication
(10) Pub. No.: US 2017/0033649 A1
(43) Pub. Date: Feb. 2, 2017

(54) METHOD FOR CORRECTING UNBALANCE OF ROTOR

(71) Applicant: MINEBEA CO., LTD., Kitasaku-Gun (JP)

(72) Inventor: Masaki GOTO, YONAGO-SHI (JP)

(21) Appl. No.: 15/224,011

(22) Filed: Jul. 29, 2016

(30) Foreign Application Priority Data
Jul. 31, 2015 (JP) 2015-152593

(51) Int. Cl. H02K 15/16; H02K 1/27

(52) U.S. Cl. CPC H02K 15/165; H02K 1/2786

(57) ABSTRACT

A method is for correcting unbalance of a rotor and includes: a first adjustment process of adjusting the unbalance of the rotor at a position of a first adjustment place, the first adjustment place being defined on a first circumference having a first radius; a second adjustment process of adjusting the unbalance of the rotor at a position of a second adjustment place, the second adjustment place being defined on a second circumference having a second radius; and a third adjustment process of adjusting, after performing the first adjustment process and the second adjustment process, the unbalance of the rotor at a position of a third adjustment place, the third adjustment place being defined on a third circumference having a third radius, wherein the third radius is smaller than the first radius and the second radius.

### BACKGROUND OF THE DISCLOSURE

1. Field of the Invention

The present invention relates to a method for correcting unbalance of a rotor, and more particularly to a method of correcting unbalance of a rotor, in which the unbalance can be corrected through a simple method and a structure of the rotor can be simplified.

2. Description of the Related Art

Precision and speed of a brushless motor such as an outer rotor type progresses as the technology advances. With this type of motor, higher performance and functions are required. In such a situation, vibrations of the motor and noises generated therefrom act as a factor causing a significant damage on the performance of the motor.

In many cases, the vibrations and the noises of the motor are caused when the center of gravity of the rotor deviates from a rotation axis (hereinafter, may be referred to as unbalance of the rotor). The unbalance of the rotor occurs from eccentricity of a shaft, eccentricity due to a combination of parts of the motor, defects of the parts of the motor, or adhesion of foreign substances. Furthermore, a mass of each part of the motor is subtly different on a circumference. Therefore, even a part manufactured with accurate dimensions cannot avoid a minute different in mass, and thus it causes the unbalance of the rotor. The unbalance of the rotor not only generates the vibrations and the noises of the motor but also reduces a lifespan of the motor. This is because a load of the rotor is repeatedly applied onto a bearing. Therefore, the correction of the unbalance of the rotor is important from a viewpoint of improving the performance of the motor.

Examples of methods for correcting the unbalance of a rotor according to the related art are disclosed in JP-A-H06(1994)-208074 and in JP-A-H06(1994)-208075.

In JP-A-H06(1994)-208074, there is disclosed a technique of attaching a plurality of balance weights differing in specific gravity in a groove portion in a surface of a rotating polygon mirror. In this technique, an adhesive having a high specific gravity is coated in the groove portion on an outer diameter side when the balance is corrected at the first time, and an adhesive having a low specific gravity is coated in the groove portion on an inner diameter side when the balance is corrected at the second time.

In JP-A-H06(1994)-208075, there is disclosed a technique of disposing balance weights in each of a circular groove formed in the outer wall surface of the rotor and a plurality of circular grooves formed in the upper surface of the rotating polygon mirror. In this technique, the balance weight is bonded to the circular groove on the outer diameter side when the balance is corrected at the first time, and the balance weight is bonded to the circular groove on the inner diameter side when the balance is corrected at the second time.

However, in the techniques disclosed in JP-A-H06(1994)-208074 and in JP-A-H06(1994)-208075, there is a need to prepare the plurality of different adhesives and different balance weights. Therefore, there is a problem in that the correction of the unbalance is complicated. In the techniques disclosed in JP-A-H06(1994)-208074 and in JP-A-H06(1994)-208075, there is a need to form the groove in all the balance correction places where the adhesive and the balance weight are provided. Therefore, the structure of the rotor is complicated.

### SUMMARY OF THE INVENTION

One of objects of the present invention is to provide a method for correcting unbalance of a rotor, in which the unbalance can be corrected through a simple method.

Another one of objects of the present invention is to further provide a method for correcting unbalance of a rotor, in which a structure of the rotor may be simplified.

According to an illustrative embodiment of the present invention, there is provided a method for correcting unbalance of a rotor, the method including: a first adjustment process of adjusting the unbalance of the rotor at a position of a first adjustment place, the first adjustment place being defined on a first circumference having a rotation axis of the rotor as a center and having a first radius, the first circumference being defined in a first plane having the rotation axis as a normal line; a second adjustment process of adjusting the unbalance of the rotor at a position of a second adjustment place, the second adjustment place being defined on a second circumference having the rotation axis as a center and having a second radius, the second circumference being defined in a second plane having the rotation axis as a normal line and is different from the first plane; and a third adjustment process of adjusting, after performing the first adjustment process and the second adjustment process, the unbalance of the rotor at a position of a third adjustment place, the third adjustment place being defined on a third circumference having the rotation axis as a center and having a third radius, the third circumference being defined in a third plane having the rotation axis as a normal line, wherein the third radius is smaller than the first radius and the second radius.

### BRIEF DESCRIPTION OF THE DRAWINGS

In the accompanying drawings:

FIG. 1 is a cross-sectional view schematically illustrating a configuration of a polygon mirror scanner motor according to an embodiment according to the present invention before unbalance of a rotor is corrected;

FIG. 2 is a diagram for describing a concept of the unbalance of the rotors;

FIG. 3 is a perspective view of a top plate 15 illustrating a first process in a method of correcting the unbalance of the rotor according to the embodiment according to the present invention;

FIG. 4 is a top view of a rotor frame 11 illustrating a second process of the method of correcting the unbalance of the rotor according to the embodiment according to the present invention;

FIG. 5 is a perspective view of the top plate 15 illustrating a third process of the method of correcting the unbalance of the rotor according to the embodiment according to the present invention;

FIG. 6 is a cross-sectional view schematically illustrating a configuration of the polygon mirror scanner motor according to the embodiment according to the present invention after the unbalance of the rotor is corrected; and

FIG. 7 is a cross-sectional view schematically illustrating of a configuration of a polygon mirror scanner motor according to a modified embodiment according to the present invention after the unbalance of the rotor is corrected.

### DETAILED DESCRIPTION

Hereinafter, an embodiment according to the present invention will be described with reference to the drawings.

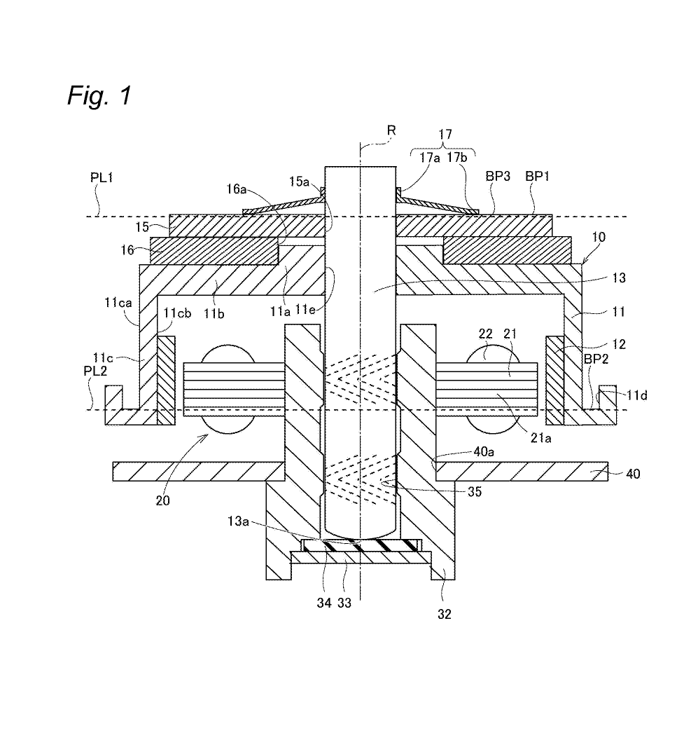

FIG. 1 is a cross-sectional view schematically illustrating a configuration of a polygon mirror scanner motor according to an embodiment before unbalance of a rotor is corrected.

The polygon mirror scanner motor according to this embodiment illustrated in FIG. 1 is a motor used to rotatably drive a polygon mirror. The polygon mirror scanner motor is mainly provided with a rotor 10 and a stator 20. The rotor 10 is supported by a stator housing 32. The rotor 10 rotates with respect to the stator 20 about a rotation axis R.

The rotor 10 includes a rotor frame 11, a magnet 12, a shaft 13, a top plate 15, a polygon mirror 16, and a presser bar spring 17. The shaft 13 is formed in a cylindrical shape. Dynamic pressure grooves are formed in any one of the shaft 13 and a portion of the stator housing 32 on an inner diameter side. The shaft 13 is provided at a position of the rotation axis R. In the rotor 10, the shaft 13 is extended in a longitudinal direction in FIG. 1 to pass through the center portion of the rotor frame 11. The rotor frame 11 is rotatable together with the shaft 13 about the rotation axis R. The magnet 12 is attached to the rotor frame 11 to face the stator 20.

The rotor frame 11 includes a rotor boss 11a, a rotor table 11b (an example of a ceiling portion), a side wall portion 11c, and a concave portion 11d. The rotor boss 11a is formed in a circular plane shape, and is fixed to an outer peripheral surface of the shaft 13. The rotor boss 11a is formed in a cylindrical shape, and protrudes upward from the rotor table 11b. The rotor boss 11a is provided at the end of the rotor table 11b on the inner diameter side. The rotor table 11b is provided in the rotor boss 11a on an outer diameter side, and extended in the outer diameter direction (a horizontal direction in FIG. 1) from the rotor boss 11a. The side wall portion 11c is extended in a downward direction from the end of the rotor table 11b on the outer diameter side.

In the center portion of the rotor boss 11a, there is provided a hole 11e through which the shaft 13 passes. The rotor frame 11 is fitted to the outer peripheral surface of the surface 13 through the hole 11e so as to be fixed to the shaft 13. The rotor table 11b is formed in a circular plane shape for example. The side wall portion 11c is formed in a cylindrical shape, and includes an outer peripheral surface 11ca which faces the outer peripheral side and an inner peripheral surface 11cb which faces the inner peripheral side. The magnet 12 is fixed to the inner peripheral surface 11cb. The concave portion 11d is formed in a circumferential plane shape, and provided in the outer peripheral surface 11ca of the side wall portion 11c. The concave portion 11d is formed by bending a lower end portion of the side wall portion 11c toward the outer diameter side, and then further bending upward.

The top plate 15 is, for example, formed in a circular plane shape, and made of metal such as aluminum. The top plate 15 includes a fitting hole 15a. The fitting hole 15a is provided in the center portion of the top plate 15. An inner peripheral surface of the fitting hole 15a is fitted to the outer peripheral surface of the shaft 13 at a position different from that of the rotor frame 11, so that the top plate 15 is fixed to the rotor 10.

The polygon mirror 16 is provided below the top plate 15. The polygon mirror 16 is formed in a polygonal plane shape. The polygon mirror 16 includes a fitting hole 16a provided in the center portion. An inner peripheral surface of the fitting hole 16a is fitted to the outer peripheral surface of the rotor boss 11a. Since the inner diameter of the fitting hole 16a is slightly larger than the outer diameter of the rotor boss 11a, there is a gap between the fitting hole 16a and the rotor boss 11a. With this gap, the polygon mirror 16 is easily detached from the rotor 10. The polygon mirror 16 is placed on the rotor table 11b. The lower surface of the polygon mirror 16 abuts on the rotor table 11b. The upper surface of the polygon mirror 16 and the lower surface of the top plate 15 abut on each other. The upper surface of the polygon mirror 16 is a substantially flat plane.

The presser bar spring 17 is provided on the top plate 15. The presser bar spring 17 includes a fitting hole 17a and a plurality of legs 17b. The fitting hole 17a is provided about the presser bar spring 17. An inner peripheral surface of the fitting hole 17a is fitted to the outer peripheral surface of the shaft 13, so that the presser bar spring 17 comes to be fixed to the shaft 13. Each of the plurality of legs 17b protrudes from the fitting hole 17a in the outer diameter direction and the downward direction at an equal interval. The end of each of the plurality of legs 17b in the outer diameter side abuts on the upper surface of the top plate 15. Therefore, the presser bar spring 17 gives an urging force to the polygon mirror 16 toward the rotor table 11b in the downward direction through the top plate 15.

The stator 20 includes a stator core 21, a stator coil 22 which is wound around a teeth portion 21a, and a base plate 40. The stator core 21 is fixed to the outer peripheral surface of the stator housing 32, and includes a plurality of teeth portions 21a which radially extend from the center toward the outside in the diameter direction. The stator core 21 is disposed on the inner peripheral side from the magnet 12 to face each other with a space interposed with respect to the magnet 12. The stator coil 22 is wound on each of the plurality of teeth portions 21a. In a case where a current flows, the stator coil 22 generates a magnetic field. A drive force (a force to rotate the rotor 10) is generated by a mutual interaction between the magnetic field of the stator coil 22 and the magnetic field of the magnet 12.

The stator 20 further includes the stator housing 32, a fixed plate 33, and a thrust receiving plate 34. The stator housing 32 includes a through hole 35. The shaft 13 is inserted into the through hole 35. The outer peripheral surface of the shaft 13, an inner peripheral surface of the through hole 35, and the thrust receiving plate 34 form a space (between the stator housing 32 and the shaft 13) which is filled with oil (not illustrated). The fixed plate 33 covers a lower end portion of the through hole 35. The thrust receiving plate 34 is disposed between the fixed plate 33 and a lower end surface 13a of the shaft 13.

A hole 40a is formed in the center portion of the base plate 40. The shaft 13 and the stator housing 32 pass through the hole 40a. While not illustrated in the drawing, the base plate 40 may be formed with a drive/control integrated circuit for driving and controlling a brushless motor, a chip-type electronic part (resistor and capacitor), and a power MOS array for turning on/off a voltage applied to each stator coil 22.

In the polygon mirror scanner motor of this embodiment, the upper surface of the top plate 15 is formed in a substantially flat plane not in a groove. In the upper surface of the top plate 15, adjustment places BP1 and BP3 are provided. In the side wall portion 11c (the concave portion 11d), an adjustment place BP2 is provided. Each of the adjustment places BP1, BP2, and BP3 is a virtual line.

Subsequently, the description will be made about a method of correcting unbalance of the rotor.

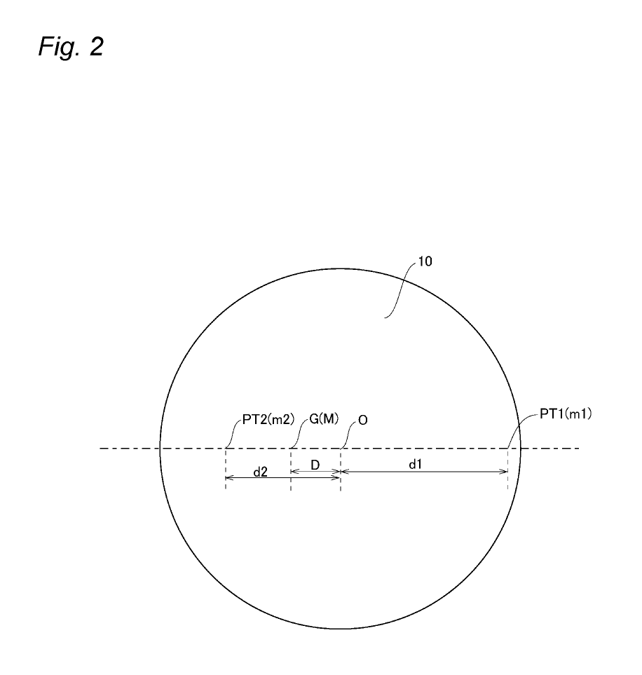

FIG. 2 is a diagram for describing a concept of the unbalance of the rotor.

In FIG. 2, the unbalance of the rotor 10 in an arbitrary plane is schematically illustrated. The unbalance of the rotor occurs due to a deviation of the gravity center of the rotor 10 from a rotation center O. For example, assuming that the rotor 10 has a mass M (mg), and the gravity center G of the rotor 10 in the plane illustrated in FIG. 2 is deviated from the rotation center O by a distance D (cm) to the left in FIG. 2. In this case, the unbalance occurs in the rotor 10 by an amount of M×D (mg·cm).

When this unbalance is removed, in the plane illustrated in FIG. 2, a weight having a mass of ml is added at a position PT1 on the opposite side to the gravity center G with respect to the rotation center O. At this time, when a distance from the rotation center O to the position PT1 is set to a distance d1, the weight and the position are selected to satisfy M×D=m1×d1. Hereinafter, the method of adjusting the unbalance by adding a weight to the rotor is referred to as a plus balance adjustment.

When the unbalance is removed, in the plane illustrated in FIG. 2, the rotor 10 may be partially removed at a position PT2 on a straight line obtained by extending a straight line connecting the gravity center G and the rotation center O toward the gravity center G. At this time, when a mass of the removed portion of the rotor 10 is set to m2, and a distance from the rotation center O to the position PT2 is set to d2, the mass m2 and the position d2 are selected to satisfy M×D=m2×d2. Hereinafter, the method of adjusting the unbalance by removing a part of the rotor 10 is referred to as a minus balance adjustment.

In either case of the plus balance adjustment and the minus balance adjustment, a mass necessary for the adjustment is increased as a distance from the rotation center O to the adjustment position is shortened. In the case of the minus balance, the subject component is removed. In this case, a specific gravity is equal in any portion of the component. Therefore, when a mass necessary for the adjustment is increased, the amount removed is increased. The amount removed can be finely adjusted. Even in the case of the plus balance, the mass necessary for the adjustment is increased using a weight having the same specific gravity. Therefore, the volume is increased and a fine adjustment can be made. As a result, the accuracy in correction of the unbalance is improved.

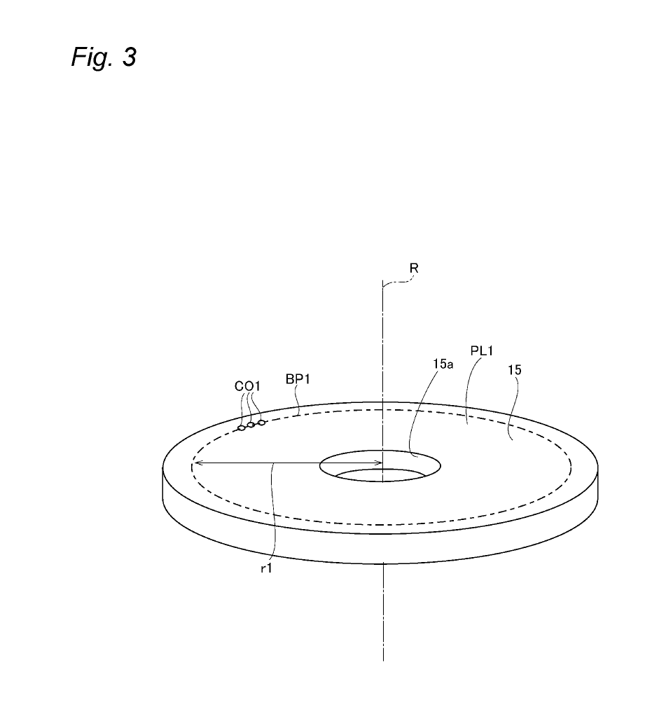

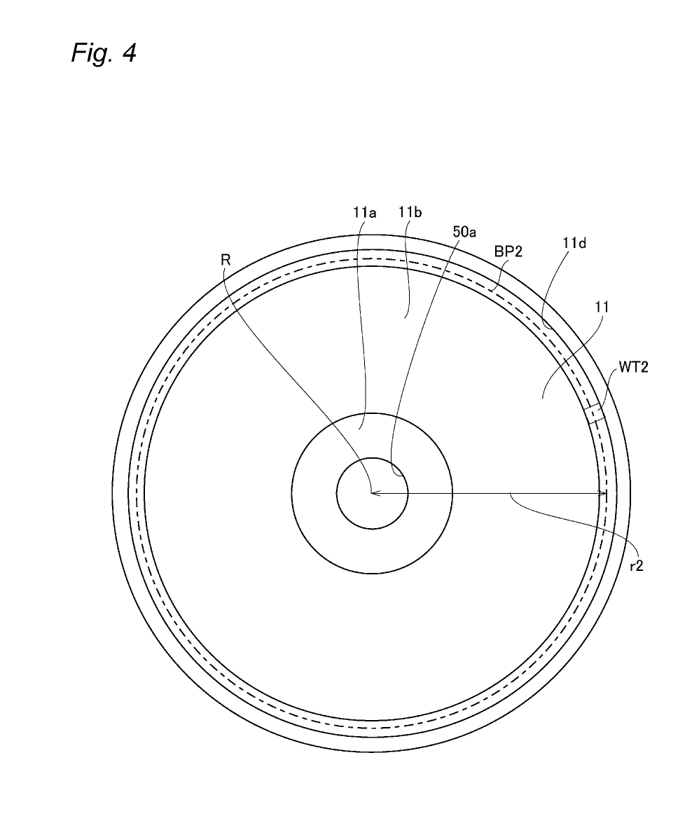

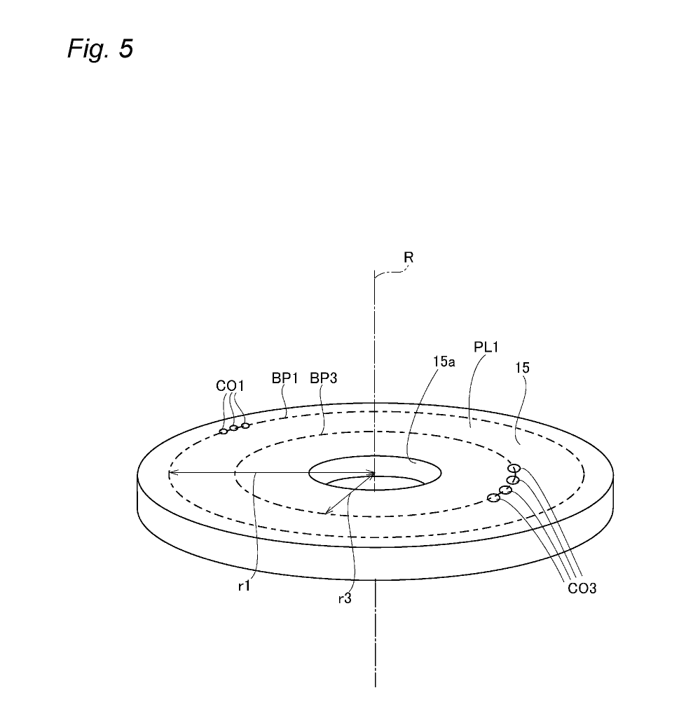

FIGS. 3 to 5 are diagrams illustrating a process sequence of the method of correcting the unbalance of the rotor according to the embodiment. FIGS. 3 and 5 are perspective views of the top plate 15, and FIG. 4 is a top view of the rotor frame 11.

In a case where the description will be made with reference to FIGS. 1 and 3, when the unbalance of the rotor 10 is corrected in the polygon mirror scanner motor according to this embodiment, a static unbalance of the rotor 10 is first adjusted in the adjustment place BP1 in a plane PL1. The plane PL1 is a plane having the rotation axis R as a normal line. The plane PL1 is preferably above the polygon mirror 16, and herein is the upper surface of the top plate 15. The adjustment place BP1 is an adjustment place on a circumference with the rotation axis R as a center.

Specifically, in the well-known method, the static unbalance of the rotor 10 in the place PL1 is measured. Then, a position at which the top plate 15 is removed on the adjustment place BP1 and a mass of the top plate 15 to be removed are determined such that the static unbalance in the plane PL1 becomes equal to or less than a predetermined value (for example, 1 mg·cm). Next, a hole (round hole) CO1 is formed at the position determined on the adjustment place BP1 (the upper surface of the top plate 15). Therefore, the minus balance adjustment is performed. The hole CO1 is formed by, for example, a drill. The mass of the top plate 15 to be removed when the hole CO1 is formed corresponds to the mass m2 described above. A distance from the rotation axis R of the hole CO1 (in other words, a radius r1 of the adjustment place BP1) corresponds to the distance d2 described above. The number of holes CO1 may be one or more.

In a case where the description will be made with reference to FIGS. 1 and 4, next the static unbalance of the rotor 10 is adjusted in the adjustment place BP2 in a plane PL2. The plane PL2 is a plane having the rotation axis R as a normal line, and different from the plane PL1. The adjustment place BP2 is an adjustment place on a circumference with the rotation axis R as a center.

Specifically, in the well-known method, the static unbalance of the rotor 10 in the plane PL2 is measured. Then, a position at which a weight WT2 is added on the adjustment place BP2 and a mass of the added weight WT2 are determined such that the static unbalance in the plane PL2 becomes equal to or less than a predetermined value (for example, 1 mg·cm). Next, the weight WT2 is added to the position determined on the adjustment place BP2. Therefore, the plus balance adjustment is performed. The mass of the weight WT2 corresponds to the mass ml described above. A distance from the rotation axis R of the weight WT2 (in other words, a radius r2 of the adjustment place BP2) corresponds to the distance d1 described above. The number of weights WT2 may be one or more.

As an example of the weight used in the adjustment of the unbalance, putty is used. As the weight, there may be used an adhesive containing a solid material such as beads or metal.

The unbalance adjustment performed on each of the adjustment places BP1 and BP2 may be a dynamic unbalance adjustment, or may be multiple unbalance adjustments. The dynamic unbalance adjustment and the multiple unbalance adjustment each are performed in the well-known method. In a case where the weight is provided in the adjustment place, the position can be adjusted at an arbitrary position in a radius direction and a circumferential direction because the concave portion is not provided as described above.

In a case where the description will be made with reference to FIGS. 1 and 5, after the unbalance in the adjustment place BP1 and the adjustment place BP2 is adjusted, the weight is adjusted in a direction to make at least any one of the static unbalance or the dynamic unbalance of the entire rotor 10 (the entire rotation body) reduced (a direction approaching zero) in the adjustment place BP3 in the plane PL1. The adjustment place BP3 is an adjustment place on a circumference with the rotation axis R as a center. A radius r3 of the adjustment place BP3 is smaller than the radius r1 of the adjustment place BP1 and the radius r2 of the adjustment place BP2.

Specifically, in the well-known method, at least any one of the static unbalance and the dynamic unbalance of the entire rotor 10 is measured. Then, a position at which a part of the top place 15 on the adjustment place BP3 is removed and a mass of the top plate 15 to be removed are determined such that at least one of the static unbalance and the dynamic unbalance becomes equal to or less than a predetermined value (for example, 0.1 mg□cm). Next, a hole (round hole) CO3 is formed at the position determined on the adjustment place BP3 (the upper surface of the top plate 15). Therefore, the minus balance adjustment is performed. The hole CO3 is formed by, for example, a drill. The mass of the top plate 15 to be removed when the hole CO3 is formed corresponds to the mass m2 described above. A distance from the rotation axis R of the hole CO3 (in other words, the radius r3 of the adjustment place BP3) corresponds to the distance d2 described above. The number of holes CO3 may be one or more. A small diameter of the drill may be used for a fine adjustment.

The above-described “static unbalance adjustment” means a multiple unbalance adjustment in which the static unbalance of the rotor is adjusted and a remaining unbalance is symmetrically adjusted to be the same amount in a right/left opposite direction (the reverse direction of 180 degrees). The description “dynamic unbalance adjustment” means a synthetic unbalance adjustment in which an unbalance obtained by combining vectors of the unbalances of right and left two faces in the dynamic unbalance is adjusted.

The radius r3 of the adjustment place BP3 is smaller than the radius r1 of the adjustment place BP1 and the radius r2 of the adjustment place BP2. Therefore, in a case where it is assumed that the same amount of the unbalance is adjusted in each of the adjustment places BP1, BP2, and BP3, a mass necessary for the unbalance adjustment in the adjustment place BP3 becomes large compared to that necessary for the unbalance adjustment in each of the adjustment places BP1 and BP2. In other words, in a case where the unbalance adjustment is performed on the outer diameter side (the adjustment place BP1), there is generated a large inertia force. Therefore, a large variation in the balance of the rotor results from a small amount of mass. On the other hand, in a case where the unbalance is on the inner diameter side (the adjustment place BP3), a small inertia force is generated. Therefore, a high mass for changing the balance of the rotor is required. In other words, in the case of the negative balance, the subject component is partially removed. In this case, a specific gravity is equal in any portion of the component. Therefore, when a mass necessary for the adjustment is increased, the amount removed is increased. The amount removed can be finely adjusted. Even in the case of the plus balance, the mass necessary for the adjustment is increased using a weight having the same specific gravity. Therefore, the volume is increased and a fine adjustment can be made. The unbalance adjustment in the adjustment place BP3 can be more finely made by comparing the unbalance adjustments of the respective adjustment places BP1 and BP2. As a result, after the unbalance adjustment is performed in the adjustment places BP1 and BP2, the unbalance adjustment in the adjustment place BP3 is performed, so that a fine correction can be made for the unbalance, and the accuracy of the unbalance adjustment can be improved.

Therefore, through the unbalance adjustments in the adjustment places BP1 and BP2, the adjustment is made to an extent of a limit point of an adjustment accuracy of a balance machine. Then, through the balance adjustment in the adjustment place BP3, the adjustment can be made exceeding the limit of the balance machine (that is, a so-called zero balance). Through the unbalance adjustment in the adjustment place BP3, a fine adjustment can be performed by performing the adjustment with a high mass.

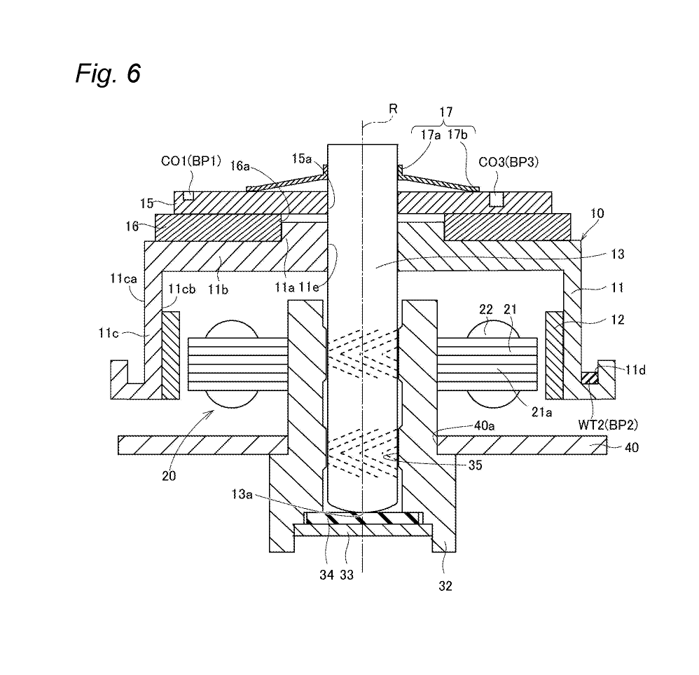

FIG. 6 is a cross-sectional view schematically illustrating a configuration of the polygon mirror scanner motor according to the embodiment after the unbalance of the rotor is corrected.

In a case where the description will be made with reference to FIG. 6, the holes CO1 and CO3 each having a necessary size are formed at necessary positions of the adjustment places BP1 and BP3 in the upper surface of the top plate 15. The weight WT2 having a necessary mass is provided at a necessary position of the adjustment place BP2 in the concave portion 11d.

According to this embodiment, in a third adjustment process, the unbalance of the rotor is adjusted on the substantially flat plane not in the groove. Therefore, the configuration such as a groove for fixing the weight may be omitted. As a result, the unbalance can be corrected by a simple method. The structure of the rotor can be suppressed from being complicated. Furthermore, the cost can be reduced. The unbalance of the rotor is adjusted in the adjustment places BP1 and BP3 through the minus balance adjustment. With this configuration, the weight necessary for the plus balance adjustment and the groove for fixing the weight can be omitted. As a result, the unbalance can be corrected by a simple method. The structure of the rotor can be suppressed from being complicated. Furthermore, the cost can be reduced.

In this embodiment, the rotor 10 may be not provided with the top plate 15. The adjustment places BP1 and BP3 each may be provided in the upper surface of the polygon mirror 16.

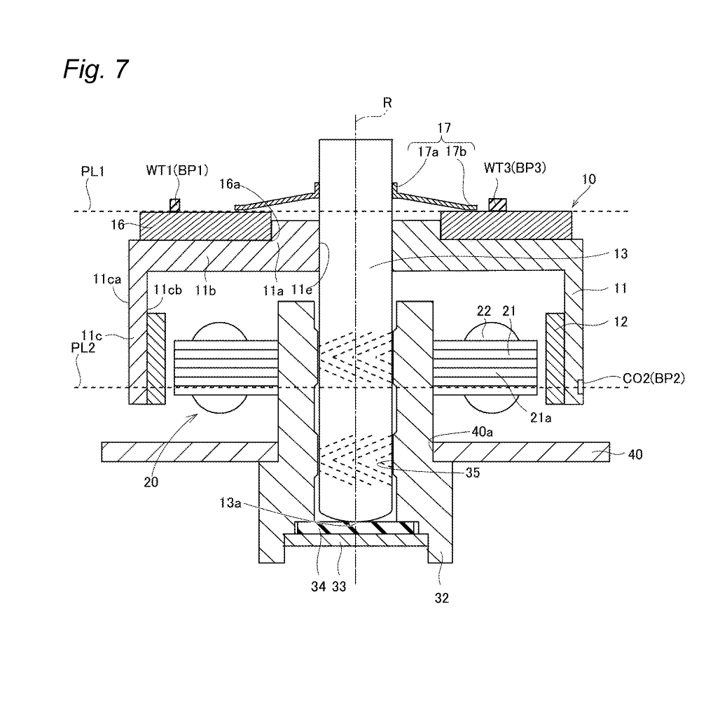

FIG. 7 is a cross-sectional view schematically illustrating a configuration of the polygon mirror scanner motor according to a modified embodiment after the unbalance of the rotor is corrected.

In a case where the description will be made with reference to FIG. 7, in this modification, the top plate is not provided, and the adjustment places BP1 and BP3 are provided in the upper surface of the polygon mirror 16. The upper surface of the polygon mirror 16 is a substantially flat plane. The plus balance adjustment is performed in each of the adjustment places BP1 and BP3, and the minus balance adjustment is performed in the adjustment place BP2. The weights WT1 and WT3 having a necessary size each are provided at necessary positions in the adjustment places BP1 and BP3 of the upper surface of the polygon mirror 16. The upper surface of the polygon mirror 16 is a substantially flat plane, and there is no groove formed for fixing the weight. Each of the weights WT1 and WT3 protrudes upward from the upper surface of the polygon mirror 16. The weights WT1 and WT3 are made of the same material. In other words, the weights that are used have the same material and the same specific gravity. The number of each of the weights WT1 and WT3 may be one or more.

In the rotor frame 11, the concave portion 11d is not provided. The adjustment place BP2 is provided at a position in the plane PL2 in the outer peripheral surface 11ca of the side wall portion 11c. A hole CO2 having a necessary size is formed at a necessary position of the adjustment place BP2 of the outer peripheral surface 11ca of the side wall portion 11c. The number of holes CO2 may be one or more.

As described in this modification, in a case where the plus balance adjustment is performed in at least two places (herein, the adjustment places BP1 and BP3) among the adjustment places BP1, BP2, and BP3, the weights (herein, the weights WT1 and WT3) having the same material and the same specific gravity are used.

In this modification, the rotor 10 may include the top plate. Each of the adjustment places BP1 and BP3 may be provided in the upper surface of the top plate. In a case where the top plate is used in the plus balance adjustment, and the weights used in the plus balance adjustment are made of putty, it is desirable that the top plate be made of copper-based metal or aluminum which is preferably to used with the putty.

The configurations of the motor and the method of correcting the unbalance of the rotor other than the description of this modification are similar to the case of the embodiment described above. Therefore, the same members will be denoted with the same symbols, and the descriptions thereof will not be repeated.

According to this modification, the unbalance of the rotor is adjusted in the adjustment places BP1 and BP3 through the plus balance adjustment using the weights made of the same material. Therefore, there is no need to prepare a plurality of weights having different specific gravity. The unbalance of the rotor is adjusted in the adjustment place BP2 through the minus balance adjustment. Therefore, the weights necessary for the plus balance adjustment and the configuration such as the groove for fixing the weights can be omitted from the adjustment place BP2. Furthermore, the top plate can be omitted. As a result, the unbalance can be corrected by a simple method. The structure of the rotor can be suppressed from being complicated. Furthermore, the cost can be reduced.

Since there is no groove for fixing the respective weights WT1 and WT3, the unbalance can be corrected by a simple method. The structure of the rotor can be suppressed from being complicated.

Herein, in the technique disclosed in JP-A-H06(1994)-208075, there is a need to form a groove in advance at all the positions where the weights are provided. Therefore, there is a need to perform the balance adjustment by the diameter of the groove, and it is not possible to perform the adjustment in a different diameter. In order to compensate the strength of the top plate which is reduced by the groove formed therein, there is a need to increase a thickness of other portion or to provide a partition in the groove to reinforce the strength. As a result, the mass is increased and the structure is complicated. In a case where the partition is formed, the adjustment place may be on the partition, and thus it is not desirable. In this modification, there is no need to provide a groove in advance in any of the adjustment positions BP1, BP2, and BP3. Therefore, the adjustment can be performed at any position in the diameter direction and the circumferential direction. Regarding the position and the balance adjustment, it is possible to employ a configuration in which a coating machine for the plus balance automatically moves to an adjustment position detected by the balance machine. A configuration may be employed in which a cutting machine tool for the minus balance automatically moves.

The unbalance of the rotor may be adjusted by adding the weight on the substantial flat plane not on the groove in at least one of the adjustment places BP1, BP2, and BP3. With this configuration, it is possible to achieve the above effect obtained when the groove is not formed in advance can be obtained.

The respective positions of the adjustment places BP1, BP2, and BP3 may be arbitrary. The adjustment place BP3 may be provided in a plane which has the rotation axis R as its normal line and is different from the planes PL1 and PL2.

The method of adjusting the unbalance in each of the adjustment places BP1, BP2, and BP3 may be performed by the plus balance adjustment, or the minus balance adjustment, or may be performed by combining the plus balance adjustment and the minus balance adjustment. As the method of adjusting the unbalance in each of the adjustment places BP1, BP2, and BP3, an appropriate method may be selected according to each adjustment place. In a case where the minus balance adjustment is performed, a portion of the rotor 10 may be removed. Furthermore, the unbalance may be adjusted in another adjustment place in addition to the adjustment places BP1, BP2, and BP3.

The rotor being the correction target of the method according to the embodiments may be a rotor of an outer-rotor-type motor such as an impeller of a fan motor other than the polygon mirror scanner motor. The rotor of an inner-rotor-type motor or a surface facing motor may be employed.

As described with reference to the embodiments, according to the present invention, the unbalance can be corrected through a simple method. According to the present invention, the structure of the rotor can be simplified.

The above-described embodiments are given as merely exemplary, and it is not intended to limit the present invention. The scope of the present invention is not limited to the above description but intended to contain all the modifications within the meanings and the scope of the claims and their equivalents.

What is claimed is:

1. A method for correcting unbalance of a rotor, the method comprising:
a first adjustment process of adjusting the unbalance of the rotor at a position of a first adjustment place, the first adjustment place being defined on a first circumference having a rotation axis of the rotor as a center and having a first radius, the first circumference being defined in a first plane having the rotation axis as a normal line;
a second adjustment process of adjusting the unbalance of the rotor at a position of a second adjustment place, the second adjustment place being defined on a second circumference having the rotation axis as a center and having a second radius, the second circumference being defined in a second plane having the rotation axis as a normal line and is different from the first plane; and
a third adjustment process of adjusting, after performing the first adjustment process and the second adjustment process, the unbalance of the rotor at a position of a third adjustment place, the third adjustment place being defined on a third circumference having the rotation axis as a center and having a third radius, the third circumference being defined in a third plane having the rotation axis as a normal line,
wherein the third radius is smaller than the first radius and the second radius.

2. The method according to claim 1,
wherein a plus balance adjustment is performed in at least two of the first adjustment process, the second adjustment process, and the third adjustment process, and
wherein a weight used for the plus balance adjustment has the same material and the same specific gravity.

3. The method according to claim 1,
wherein a minus balance adjustment is performed in at least two of the first adjustment process, the second adjustment process, and the third adjustment process.

4. The method according to claim 1,
wherein at least one of a static unbalance and a dynamic unbalance of an entire rotor is adjusted in the third adjustment process.

5. The method according to claim 1,
wherein the first plane and the third plane are the same plane.

6. The method according to claim 1,
wherein the rotor is a rotor of an outer-rotor-type motor including a stator core wound with a coil and the rotor equipped with a magnet facing the stator core on an outer diameter side of the stator core.

7. The method according to claim 6,
wherein the rotor includes:
a shaft that rotates about the rotation axis;
a rotor frame that is fixed to an outer peripheral surface of the shaft; and
a polygon mirror that is provided on the rotor frame,
wherein the rotor frame includes:
a ceiling portion that extends in an outer diameter direction from an end portion on an inner diameter side fixed to the outer peripheral surface of the shaft; and
a side wall portion that extends in an extending direction of the rotation axis from the outer diameter side of the ceiling portion, and provided with the magnet fixed to an inner peripheral surface,
wherein the first adjustment place and the third adjustment places is provided in the same plane above the polygon mirror, and
wherein the second adjustment place is provided in the side wall portion.
